(19) United States
(12) Patent Application Publication
(10) Pub. No.: US 2019/0000227 A1
(43) Pub. Date: Jan. 3, 2019

(54) HEIGHT ADJUSTABLE MONITOR STAND INCORPORATING A CHARGING STATION

(71) Applicant: FIRST BASE INC, Woodbridge (CA)

(72) Inventor: Jean-Pierre Cayer, Toronto (CA)

(21) Appl. No.: 16/022,954

(22) Filed: Jun. 29, 2018

Related U.S. Application Data
(60) Provisional application No. 62/527,355, filed on Jun. 30, 2017.

(51) Int. Cl. A47B 21/06; A47B 21/02; A47B 21/04; H02J 7/00; H02J 7/02

(52) U.S. Cl. CPC A47B 21/06; A47B 21/02; A47B 21/04; H02J 7/0045; H02J 7/0052; H02J 2007/0062; H02J 7/027; A47B 2021/066; A47B 2200/005; A47B 2200/0066; H02J 7/025

(57) ABSTRACT

A monitor stand including a plate with one or more stacks of risers extending downwardly from the plate's bottom surface. A user may adjust the height of the plate relative to a support surface by adding or subtracting risers to each of the one or more stacks. At least one of the risers includes a charging station. The location or orientation of the charging station relative to the plate may be selectively changed by switching the location or orientation of the riser having the charging station. The plate may be rectangular or triangular in shape. One of more computing devices may be placed on the plate's upper surface and be connected to the charging station by cables. The stand may be connected to a remote power source to provide power to the charging station and thereby to charge the connected devices.

### CROSS REFERENCE TO RELATED APPLICATION

This application claims the benefit of U.S. Provisional Application Ser. No. 62/527,355, filed on Jun. 30, 2017; the disclosure of which is incorporated herein by reference.

### BACKGROUND

### Technical Field

Generally, the current disclosure relates to an accessory for computing devices. More particularly, the current disclosure is directed to a monitor stand. Specifically, the current disclosure relates to an adjustable height monitor stand having a charging station that may be selectively movable from one location on the monitor stand to another.

### Background Information

A monitor stand may be used by people who work on computers for many hours a day or who work on devices like laptops. Because of the size of a laptop, a person may have to bend their neck to look down at the screen. If people have to look down at a monitor or laptop for many hours, they may develop “forward neck syndrome” or “turtle neck syndrome” which may cause sharp pain in the neck and back.

Monitor stands may be used to prevent some of these neck and back problems since a monitor stand will raise the height of the screen so that the person does not have to look downwardly. By adjusting the height of the monitor stand, people can position the screen or monitor at more or less the same level as their eyes.

There are many monitor stands proposed in the prior art. These monitor stands may include a plate and downwardly extending legs. Some of monitor stands may include fixed height legs. Other monitor stands may have legs whose height can be adjusted so that the monitor may be set at a different height relative to a supporting surface. Some of monitor stands in the prior art may have a USB charging port built-in on the plate portion of the stand so that a user can plug an electronic device into the charging port to charge the device. Typically, these charging ports are built into one of the faces of the plate portion of the stand.

### SUMMARY

Issues continue to exist with ports on monitor stands. Particularly, the positioning of a port on the plate or tabletop portion of the stand can cause problems in charging an electrical device. For example, if the tabletop is raised, the port is also raised, which could increase the distance needed for a power cord. If a user does not have an extended power cord, the device may not be able to be charged. Thus, there remains a need in the art for an improved monitor stand. The present disclosure addresses these and other issues.

In accordance with one aspect, an exemplary embodiment of the present disclosure may provide a monitor stand comprising: a plate having a first surface and a second surface and the plate is adapted to support an object; a plurality of riser connected to the plate; wherein at least one riser from the plurality of risers includes a charging station adapted to provide power to an electrical device, wherein a position of the at least one riser including the charging station is variable relative to the plate. This exemplary embodiment or another exemplary embodiment may further provide a first position of the plate and a second position of the plate that is vertically different than the first position; wherein the plurality of risers are interconnected to move the plate from the first position to the second position. This exemplary embodiment or another exemplary embodiment may further provide an interlocking engagement between the at least one riser including the charging station and a second riser; a first engagement position with the at least one riser including the charging station above the second riser; and a second engagement position with the at least one riser including the charging station below the second riser. This exemplary embodiment or another exemplary embodiment may further provide a third riser; a third engagement position with the at least one riser including the charging station below the second riser and the third riser; a fourth engagement position with the at least one riser including the charging station above the second riser and the third riser; a fifth engagement position with the at least one riser including the charging station between the second riser and the third riser. This exemplary embodiment or another exemplary embodiment may further provide an interlocking engagement between the at least one riser including the charging station and the second surface of the plate; a first riser position with at least one riser including the charging station adjacent a first end of the plate below the second surface; and a second riser position with at least one riser including the charging station adjacent a second end of the plate below the second surface. This exemplary embodiment or another exemplary embodiment may further provide a spacing of the charging station relative to the second surface of the plate that is equal in the first riser position and the second riser position. This exemplary embodiment or another exemplary embodiment may further provide a spacing of the charging station relative to the second surface of the plate that is different in the first riser position than in the second riser position. This exemplary embodiment or another exemplary embodiment may further provide a power source coupled with the charging station; a first device placement position relative to an upper surface of the plate to charge the electrical device with the power source via the charging station; a second device placement position relative to an upper surface of the plate to charge the electrical device with the power source via the charging station, wherein the second device placement position is horizontally translated to a different location relative to the plate than the first device placement position. This exemplary embodiment or another exemplary embodiment may further provide a power source coupled with the charging station; a first device placement position relative to an upper surface of the plate to charge the electrical device with the power source via the charging station; a second device placement position relative to an upper surface of the plate to charge the electrical device with the power source via the charging station, wherein the second device placement position is moved vertically to a different location relative to the plate than the first device placement position. This exemplary embodiment or another exemplary embodiment may further provide wherein the charging station includes at least one of a universal serial bus (USB) and a wireless charging pad. This exemplary embodiment or another exemplary embodiment may further provide an upper surface of the plate defining a major surface area and an opposed bottom surface; a plurality of ribs formed in the bottom surface adapted to strengthen the plate; a first slot defined in the bottom surface of the plate adjacent the plurality of ribs; a second slot defined in the bottom surface of the plate adjacent the plurality of ribs spaced apart from the first slot; a first engagement position where the at least one riser including the charging station is engaged with the first slot; and a second engagement position where the at least one riser including the charging station is engaged with the second slot. This exemplary embodiment or another exemplary embodiment may further provide wherein the at least one riser including the charging station is one of laterally moveable, vertically moveable, and rotatable relative to the plate. This exemplary embodiment or another exemplary embodiment may further provide a raised position and a lowed position of the plate; wherein a vertical spacing of the at least one riser including the charging station relative to a top surface of the plate remains equal when the position of the at least one riser including the charging station is laterally moved relative to the plate and as the plate is moved between the raised position and the lowered position. This exemplary embodiment or another exemplary embodiment may further provide wherein each riser from the plurality of risers includes: a top end and a bottom end of each riser; wherein the top end is formed with one of a male connector and a female connector; and wherein the bottom end is formed with the other of a male connector and a female connector. This exemplary embodiment or another exemplary embodiment may further provide wherein each male and female connector has identically shaped sides to allow for assembly in more than one orientation relative to a vertical axis of the riser.

In accordance with one aspect, an exemplary embodiment of the present disclosure may provide a charging system comprising: a plate having an upper surface and an opposed lower surface that is moveable between a raised position and a lowered position; a first riser located under the lower surface of the plate that is variable relative to the plate to effectuate movement of the plate between the raised position and the lowered position; a charging station located on the first riser that is variable in location relative to an engagement position with the plate; a power source coupled with the charging station; an electronic device; and an electrical connection between the electronic device and the charging station, wherein the electrical connection may be selected from the group comprising (i) a wired connection and (ii) a wireless connection. The charging station may comprise at least one of a USB port, an electrical outlet, a circuit board, a wireless charging pad, and an LED indicator.

In accordance with one aspect, an exemplary embodiment of the present disclosure may provide a method comprising: varying a position of a riser including a charging station relative to a surface on a plate; connecting an electrical device to the charging station; and charging the electrical device. This exemplary method may further provide moving the plate between a raised position and a lowered position, wherein moving the plate is accomplished by altering a number of risers that are stacked below the plate; and varying the position of the riser including the charging station in the number of risers stacked below the plate. The method may also provide interlocking the plurality of risers together; interlocking one riser to a bottom surface of the plate in a first slot defined in the bottom surface of the plate adjacent a plurality of ribs; interlocking one riser to the bottom surface of the plate in a second slot defined in the bottom surface of the plate adjacent the plurality of ribs spaced apart from the first slot; and moving the at least one riser including the charging station from a first engagement position with the first slot to a second engagement position with the second slot.

In accordance with one aspect, an exemplary embodiment may provide a monitor stand that includes a plate or tabletop with one or more risers that extend downwardly from a bottom surface of the plate. A computing device may be placed on an upper surface of the plate. The monitor stand not only allows a user to adjust the height of the plate relative to a support surface but also permits a user to customize the monitor stand by being able to change a position of charging station or connector port (such one or more USB ports) from one location on the monitor stand to another. The height of the monitor stand may be adjusted by adding or subtracting risers that extend downwardly from the plate. At least one of the risers includes the charging station or connector port. By switching the location or orientation of the riser that includes the charging station or connector port, the location of the charging station or connector port may be relocated relative to the plate. The plate may be rectangular or triangular in shape and one of more computing devices may be connected to the charging station or connector port via cables. The monitor stand may be connected to a remote power source to provide power to the charging station/connector port. When the power is provided to the charging station, then the devices connected to the charging station will be charged. An LED indicator provided on the riser with the charging station will be illuminated appropriately to show that the charging station is in use or is ready for use.

In one aspect, the present disclosure may provide a monitor stand comprising a plate having an upper surface, a lower surface, and a sidewall or minor surface area defined by the thickness of the plate between the first surface and the second surface that extends between the upper surface and the lower surface; a first riser positioned under the lower surface of the plate; and a charging station provided on the first riser; wherein the charging station is adapted to be connected to an electronic device. The first riser is movable relative to the plate; and when the first riser is moved relative to the plate, the position of the charging station relative to the plate may be changed. The first riser may be movable laterally relative to the plate or the first riser is rotatable relative to the plate. Alternatively, the first riser may be movable vertically relative to the plate.

In another aspect, the present disclosure may provide, in combination, a plate having an upper surface, a lower surface, and a sidewall that extends between the upper surface and the lower surface; a first riser located under the lower surface of the plate; a charging station located on the first riser; an electronic device; and a cable extending between the electronic device and the charging station.

In another aspect, the present disclosure may provide a method of assembling a monitor stand comprising providing a plate having an upper surface, a lower surface, and a sidewall extending between the upper surface and the lower surface; positioning a first riser beneath the lower surface of the plate; and interlocking the first riser to the plate, wherein an electrical port is carried by the riser and the port may be moved relative to the platform by attaching another riser between the first riser and the plate after disconnecting the first riser from the plate.

The method may further comprise inserting a second riser above or below the first riser; and adjusting a height of the plate relative to a support surface. The method further comprises a step of moving the first riser relative to the plate; and changing a position of a charging station on the first riser relative to the plate. The step of moving the first riser relative to the plate may further comprise rotating the first riser relative to the plate or the step of moving the first riser relative to the plate may further comprise laterally moving the first riser relative to the plate. Alternatively, the step of moving the first riser relative to the plate may further comprise vertically moving the first riser relative to the plate.

In another aspect, an embodiment of the present disclosure may provide a monitor stand comprising: a plate that is moveable between a first position and a second position; at least one riser position below the plate wherein the plate is in the first position; at least two vertically aligned risers positioned below the plate when the plate is in the second position; and a charging station carried by one of the risers that is selectively moveable relative to plate, wherein the charger station is adapted to provide electrical signals to an electronic device that is at least indirectly coupled to the charging station proximate the plate.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 (FIG. 1) is a diagrammatic front elevation view of a computer monitor on a monitor stand of a first embodiment, a remote power source, and electronic device connected to a charging station provided one of the monitor stand risers.

FIG. 2 (FIG. 2) is a top perspective view of the first embodiment of a monitor stand in accordance with the present disclosure.

FIG. 3 (FIG. 3) is a front elevation view of the first embodiment of the monitor stand.

FIG. 4 (FIG. 4) is a side elevation view of the first embodiment of the monitor stand.

FIG. 5 (FIG. 5) is an exploded front elevational view of the first embodiment of the monitor stand.

FIG. 6 (FIG. 6) is a bottom plan view of the plate of the monitor stand taken along line 6-6 in FIG. 5.

FIG. 7A (FIG. 7A) is a top perspective view of a first embodiment of a rectangular riser in accordance with the present disclosure.

FIG. 7B (FIG. 7B) is a top perspective view of a square riser in accordance with the present disclosure.

FIG. 8A (FIG. 8A) is a bottom perspective view of the rectangular riser of FIG. 7A.

FIG. 8B (FIG. 8B) is a bottom perspective view of the square riser of FIG. 7B.

FIG. 9 (FIG. 9) is a top perspective view of a second embodiment of rectangular riser in accordance with the present disclosure.

FIG. 10 (FIG. 10) is a bottom perspective view of the riser of FIG. 9.

FIG. 11 (FIG. 11) is a cross-section of the riser taken along line 11-11 of FIG. 9.

FIG. 12 (FIG. 12) is a cross-section of the riser taken along line 12-12 in FIG. 9.

FIG. 13 (FIG. 13) is a cross section view of the monitor stand taken along line 13-13 of FIG. 2.

FIG. 14 (FIG. 14) is a top perspective view of a second embodiment of the monitor stand in accordance with the present disclosure.

FIG. 15 (FIG. 15) is a front elevation view of the second embodiment of the monitor stand.

FIG. 16 (FIG. 16) is right side elevation view of the second embodiment of the monitor stand.

FIG. 17 (FIG. 17) is a bottom plan view of the second embodiment of the monitor stand.

Similar numbers refer to similar parts throughout the drawings.

### DETAILED DESCRIPTION

The present disclosure relates to a monitor stand for supporting and charging one or more computing devices. The monitor stand may be easily adjusted in height and includes a charging station that may be selectively positioned at any of a number of different locations on the stand. The user is able to quickly and easily relocate the charging station to suit the user's personal needs.

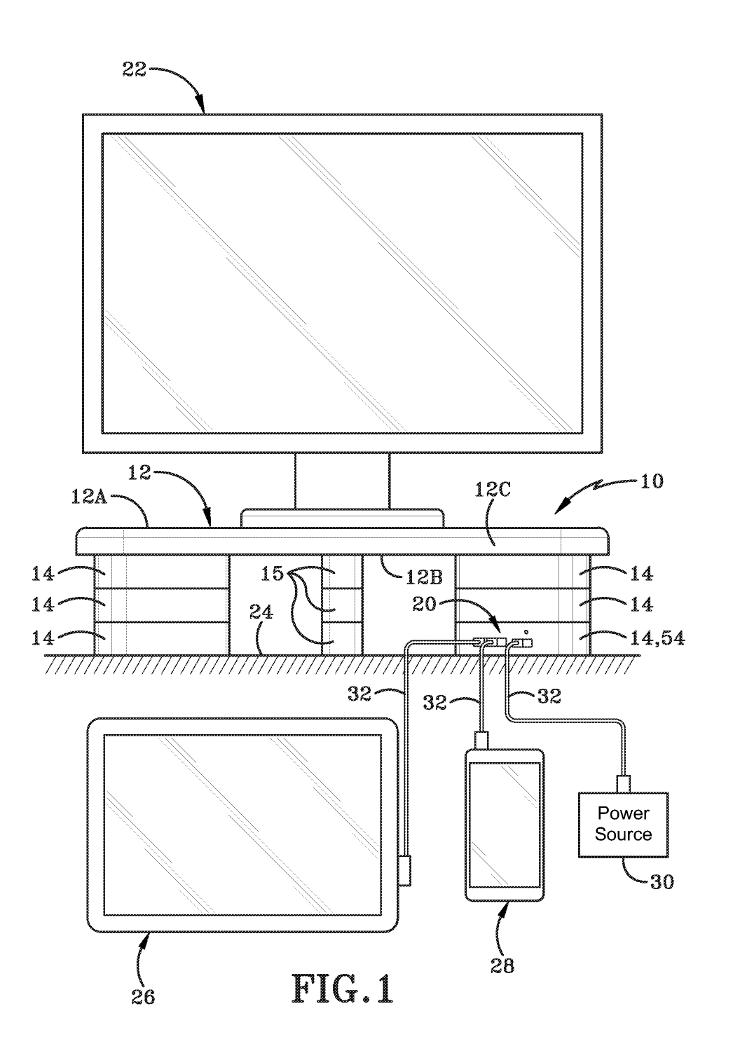

FIG. 1 depicts an exemplary view of a first embodiment of a monitor stand 10 in accordance with an aspect of the present invention. Monitor stand 10 may comprise a plate 12 and a plurality of risers. In the first embodiment there are three different types of risers utilized and these risers are identified by the reference numbers 14, 15 and 54. Risers 14 are generally rectangular in shape; risers 15 are generally square in shape, and riser 54 may be generally rectangular in shape and includes a charging station 20.

Monitor stand 10 is designed to be used by placing computing device 22, such as a computer monitor or a laptop computer, onto plate 12. The computing device 22 is supported by monitor stand 10 and specifically plate 12 at a distance vertically above a support surface 24. The computing device 22 and/or an electronic device such as a tablet 26 and/or a smart phone 28 may be operatively engaged with or connected to charging station 20. Cables 32 are used to connect tablet 26, smartphone 28, and/or the computing device 22 to charging station 20. Charging station 20 on monitor stand 10 may be connected to a remote power source 30 such as a wall outlet. Power provided by power source 30 to charging station 20 allows the user to charge tablet 26 or smart phone 28. Power source 30, when connected to charging station 20 may also directly power computing device 22, tablet 26, smart phone 28 etc.

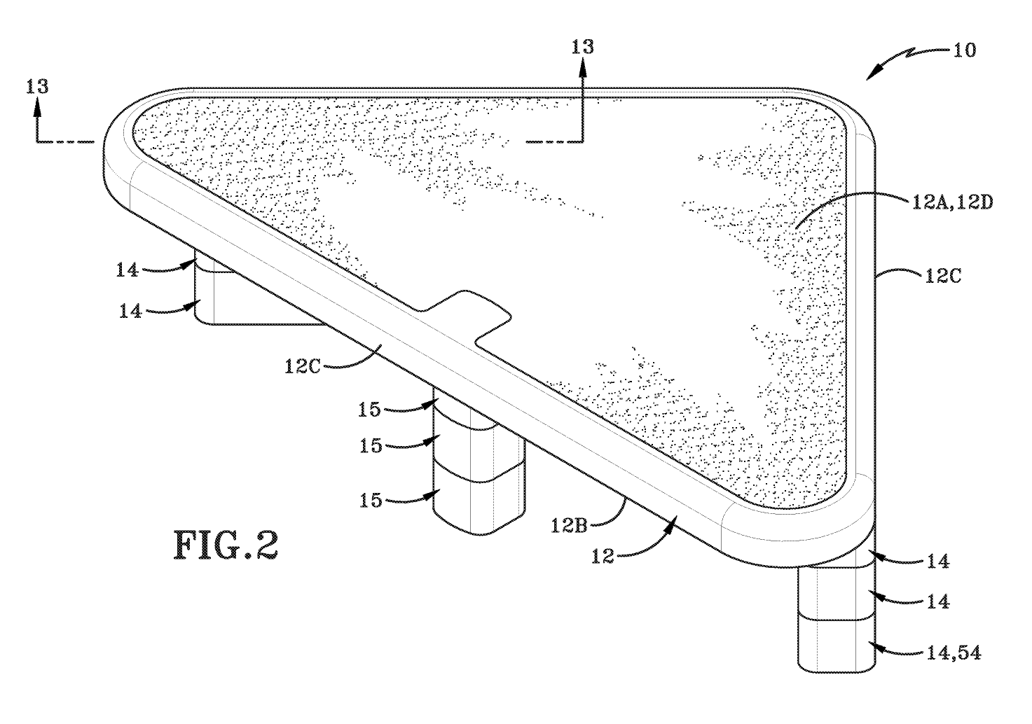

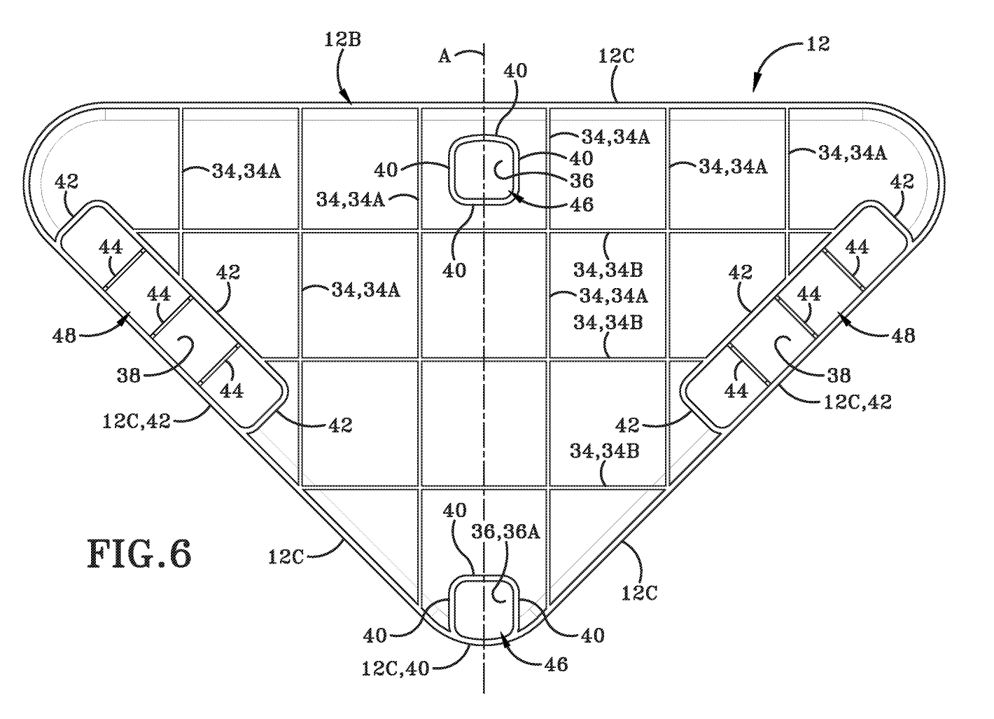

FIG. 2 shows that monitor stand 10 may comprise a triangularly-shaped plate 12 and three columns of risers 14, 15 extending downwardly from plate 12. At least one riser 54 may include a charging station 20. As depicted in FIGS. 2 and 6, plate 12 may have an upper surface 12A and a lower surface 12B. Upper surface 12A may define a major surface area of plate 12. A sidewall 12C may extend between upper surface 12A and lower surface 12B and defines the perimeter of plate 12. Sidewall 12C may define a minor surface area corresponding to the thickness of the plate between the upper surface 12A and the lower surface 12B. An edge formed where upper surface 12A meets sidewall 12C may be rounded or fillet-shaped. Upper surface 12A may include a textured area 12D as shown in FIG. 2. The textured area 12D may prevent computing device 22 placed on upper surface 12A from sliding thereon.

As depicted in FIG. 6, lower surface 12B of plate 12 may include a plurality of strengthening ribs 34 provided thereon. In one embodiment, ribs 34 may be integrally formed with the plate 12 as a single unibody monolithic member. Ribs 34 may comprise a plurality of longitudinal ribs 34A and a plurality of transverse ribs 34B. The longitudinal ribs 34A may be parallel and spaced apart from each other, and the transverse ribs 34B may be parallel and spaced apart from each other. Moreover, the longitudinal and transverse ribs 34A, 34B may be perpendicular to each other. However, in other embodiments, the ribs 34A, 34B may be non-orthogonal relative to each other. Any pattern of ribs 34 may be utilized on plate 12.

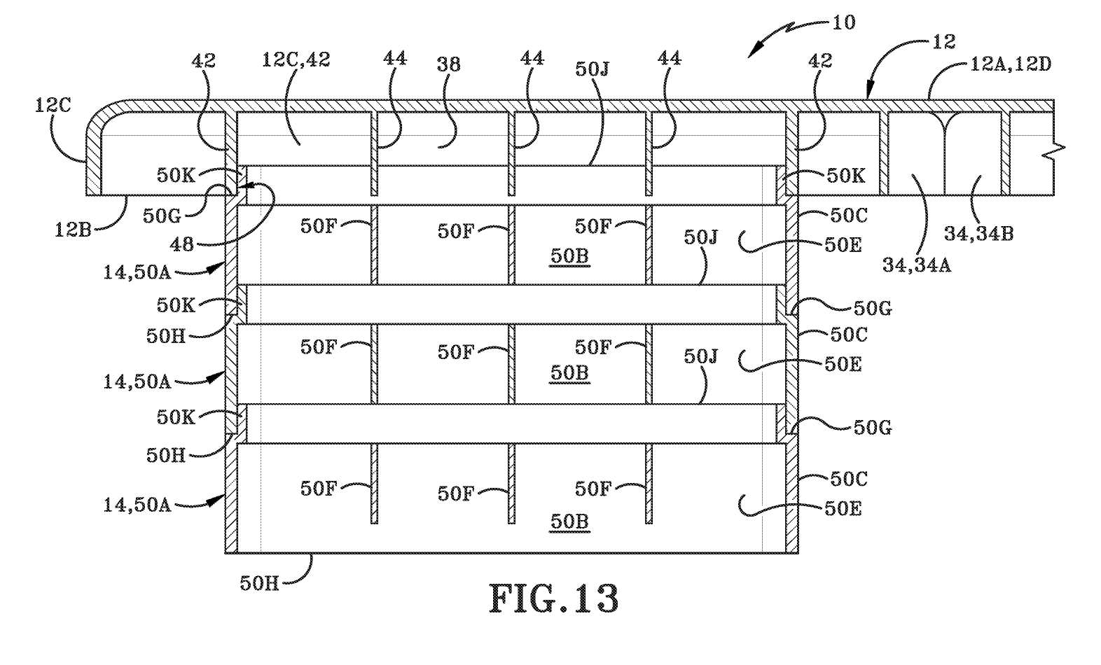

Lower surface 12B may define one or more square slots 36 and one or more rectangular slots 38 to receive and engage one or more square risers 15 and one or more rectangular risers 14 or 54 respectively. The slot 36 is defined by four walls 40 extending outwardly from lower surface 12B. Similarly, the slot 38 is defined by four walls 42 extending outwardly from lower surface 12B. Alternatively, the slot 36 or slot 38 may be defined by one or more of the longitudinal ribs 34A or transverse ribs 34B. Three ribs 44 may extend between two of the walls 42 that define slot 38. The walls 42 may extend further outwardly from lower surface 12B than do the ribs 44. The four walls 40 and lower surface 12B of plate 12 define an opening 46 to slot 36. The four walls 42, the ribs 44 and lower surface 12B define an opening 48 to slot 38. The heights of the walls 40, 42 are substantially equal to the height of sidewall 12C. This may be seen in FIG. 13.

As depicted in FIG. 6, there may be two square slots 36 and two rectangular slots 38 provided in plate 12. The two square slots 36 are located a distance apart from each other along an apical axis A of the triangular plate as shown in FIG. 6. An apical slot 36A may be partially formed by sidewall 12C or by one of the walls 40 merging with sidewall 12C. Apical slot 36A may be located at the apex of the triangular plate. The other slot 36 may be located a distance inwardly from sidewall 12C adjacent or proximate a hypotenuse wall of plate 12. The placement of slots 36 and slots 38 aids in providing side-to-side and front-to-back stability to plate 12 when risers 15 are engaged in slots 36. The rectangular slots 38 may be oriented at a non-orthogonal angle relative to the axis A. One of the walls 42 of each slot 38 may merge with or abut sidewall 12C as shown in FIG. 6. The position and orientation of slots 38 also adds to the side-to-side and front-to-back stability of plate 12 when risers 14 and 54 are engaged in slots 38.

It will be understood that in other embodiments, the location and shape of the slots 36, 38 may be different. For example, the slots may have a triangular shape or a circular shape. Complementary shaped risers will be understood to be provided for engagement in these differently shaped slots. It will further be understood that the slots 36, 38 may be located at any other desired location and orientation on lower surface 12B. Lesser or greater numbers of slots 36, 38 may also be utilized on plate 12.

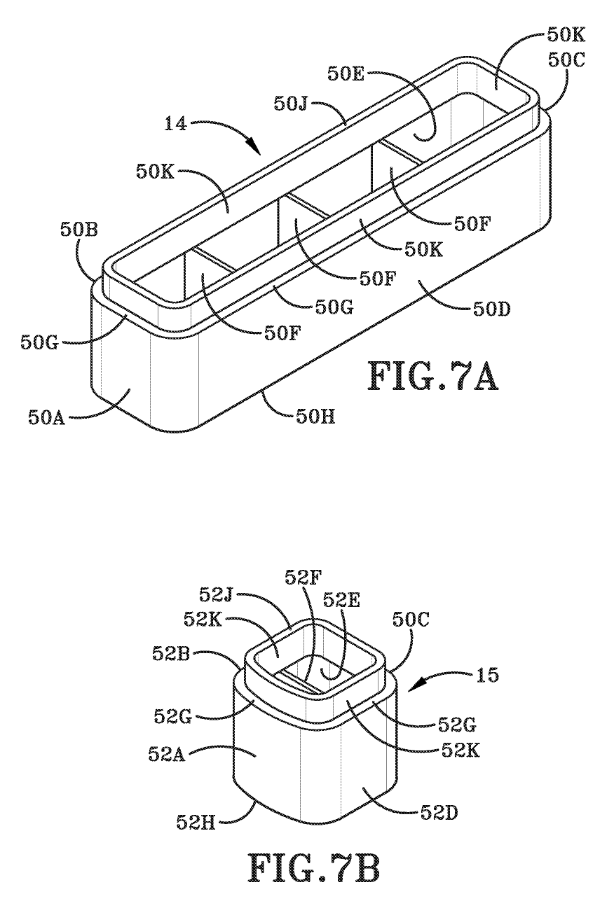

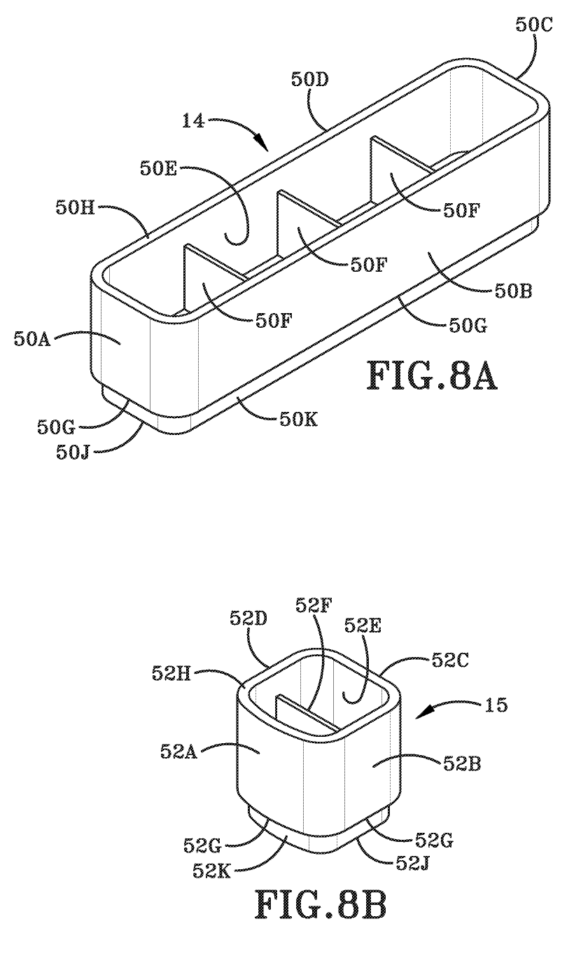

As depicted in FIGS. 7A and 8A, a riser 14 is shown in greater detail. Riser 14 may be configured to be complementary to rectangular slot 38 and is further configured to be interlockingly or frictionally engaged therein. Riser 14 may comprise a first wall 50A; a second wall 50B, a third wall 50C, and a fourth wall 50D. The corners where the four walls 50A, 50B, 50C, 50D intersect each other may be rounded. The four walls 50A, 50B, 50C, 50D may be operatively connected to each other to bound and define a space 50E. One or more ribs 50F may span the space 50E and thereby strengthen riser 14. Ribs 50F may extend between walls 50B, 50D, i.e., between the longer walls of the rectangular riser 14. Riser 14 may further include a top end 50G and a bottom end 50H, each of which bounds and defines an opening to space 50E. A flange 50K may extend upwardly beyond top end 50G and terminates in an outermost end 50J. Flange 50K has a smaller width and smaller length so as to be considered recessed relative to walls 50A, 50B, 50C, 50D. The top end of the riser 14, i.e., flange 50K is thus of reduced dimensions relative to the rest of the riser 14. It should be noted that the dimensions of flange 50K may be complementary to the opening 48 of slot 38.

Each rib 50F provided on riser 14 may originate proximate top end 50G and terminate a distance inwardly from bottom end 50H. As indicated above, flange 50K is shaped and sized to be received in the slot 38 defined by four walls 42 of plate 12. As shown in FIG. 13, when riser 14 is engaged with plate 12, the bottom ends of walls 42 rests on top end 50G of the walls 50A, 50B, 50C, 50D of riser 14.

As depicted in FIGS. 7B and 8B, a square riser 15 is shown in greater detail. Riser 15 may be configured to be complementary with and interlockingly or frictionally engaged in opening 46 of square slot 36. Riser 15 may comprise a first wall 52A, a second wall 52B, a third wall 52C, and a fourth wall 52D. The corners where the four walls 52A, 52B, 52C, 52D intersect may be rounded. The four walls 52A, 52B, 52C, 52D may be operatively connected to each other to bound and define a space 52E. One or more ribs 52F may extend between walls 52B, 52D to strengthen riser 15. Riser 15 may further include a top end 52G and a bottom end 52H, each of which bounds and defines an opening to space 52E. A flange 52K may extend upwardly beyond top end 52G of walls 52A, 52B, 52C and 52D and terminate in an uppermost end 52J. Flange 52K has a smaller width and smaller length so as to be considered recessed relative to walls 52A, 52B, 52C and 52D. Rib 52F may originate proximate top end 52G and terminate a distance inwardly from bottom end 52H. Flange 52K may be shaped and sized to be received in opening 46 to slot 36 defined by four walls 40 of plate 12. As shown in FIG. 13, when riser 15 is interlockingly engaged with plate 12, the bottom end of wall 40 may rest on top end 52G of each wall 52A, 52B, 52C, 52D of riser 15.

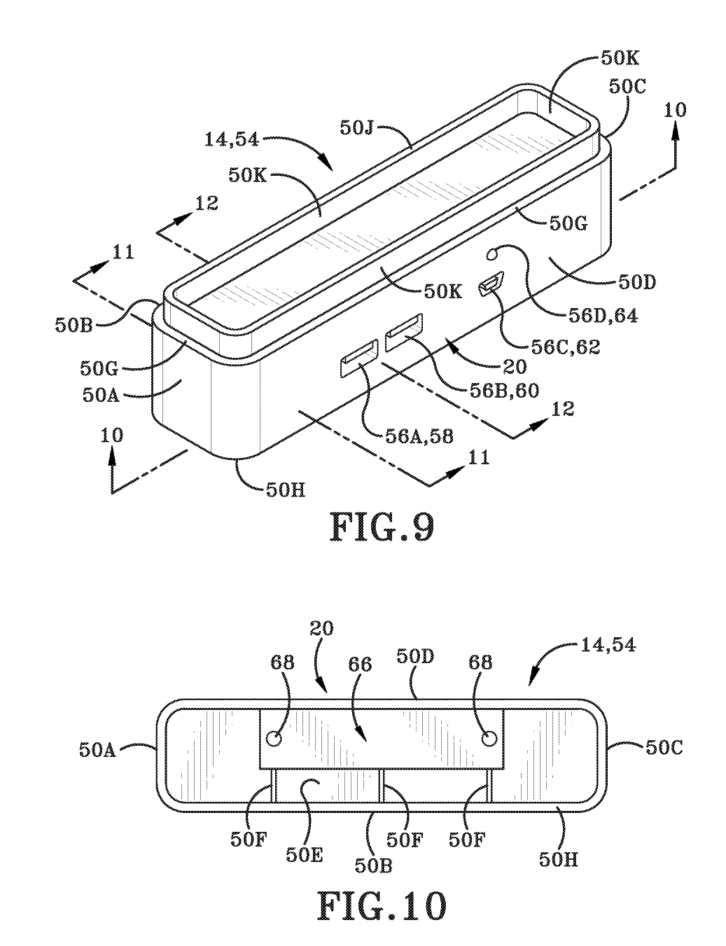

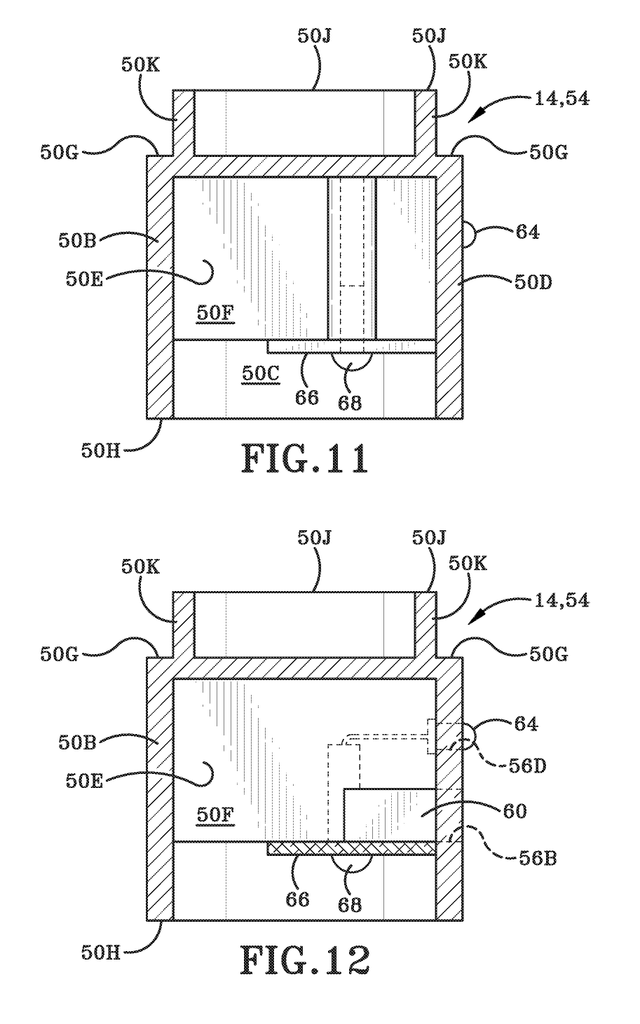

As depicted in FIGS. 9, 10, 11, and 12, one or more of the rectangular (or square) risers may include the charging station 20. The riser as illustrated herein may be one of the rectangular risers 14 and be designated herein as riser 54; however, a square riser may have a charging station 20. Riser 54 may be structurally similar to riser 14 except that one or more of the sidewalls, such as sidewall 50D, defines one or more openings therein. As illustrated in the attached figures the sidewall 50D defines a plurality of openings 56A, 56B, 56C, 56D therein. Riser 54 may also house a plurality of electrical components. The electrical components may be of a type that causes opening 56A to comprise a first USB charging port 58; the second opening 56B to comprise a second USB port 60; the third opening 56C to comprise a power port 62; and the fourth opening 56D to comprise an LED indicator 64. The LED indicator 64 may comprise a light that is appropriately illuminated to show if charging station 20 is operational, is actively charging or is finished charging any computing devices operatively engaged with charging station 20. FIG. 10 shows a circuit board 66 may also be carried by the riser 14 and in operative communication with the USB charging ports 56, 58, the power port 62, and the LED indicator 64 provided therein. Fasteners 68 may be used to secure the circuit board 66 to riser 54, particularly to the ribs 50F therein. However, in other embodiments, the circuit board 66 may be attached to one or more ribs 50F by any other suitable method, such as welding or bonding, or any other non-mechanical and non-chemical manner. Riser 54 may also include a top wall 50L as shown in FIG. 9 to protect the electrical components in the spaced 50E defined by riser 54. It will be understood that riser 54 may include at least one USB port, at least one power port, at least one LED and any other desired ports or display mechanisms that will provide improved connectivity and/or charging abilities to charging station. For example, the charging station 20 may also include a wireless module that may be placed in wireless communication with a computing device. It should be understood that the term “charging station” is used to describe any combination of ports and displays that may be provided on riser 54. When embodied as a wireless charging station, the charging station may be proximate the plate 12 such that placing a smartphone on the plate 12 above the charging station 20 on one of the risers will charge the smartphone. The wireless charging station could also be incorporated into the plate 12.

It will be understood that more openings or fewer openings such as openings 56A, 56B, 56C, 56D may be provided on riser 54. Additionally, other or different electrical components may be engaged in these additional or fewer openings to form a part of riser 54. Any type of plug and play type component may be provided on riser 54 that may be operatively engaged with a standard or customized computing device.

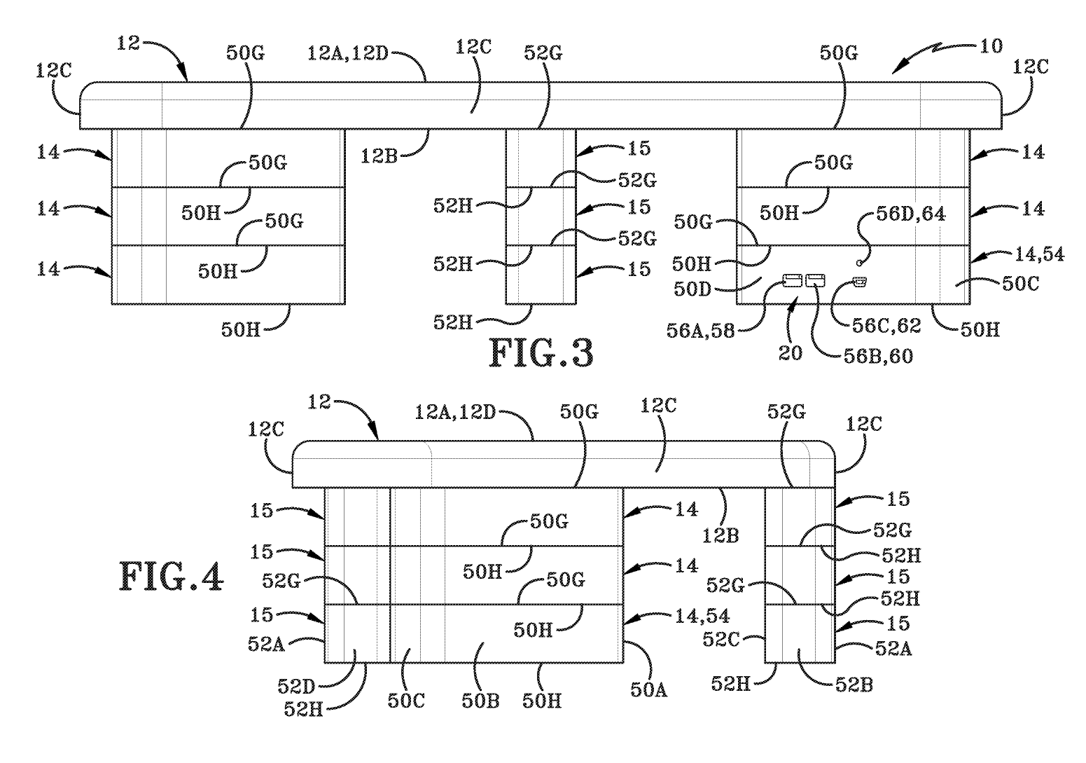

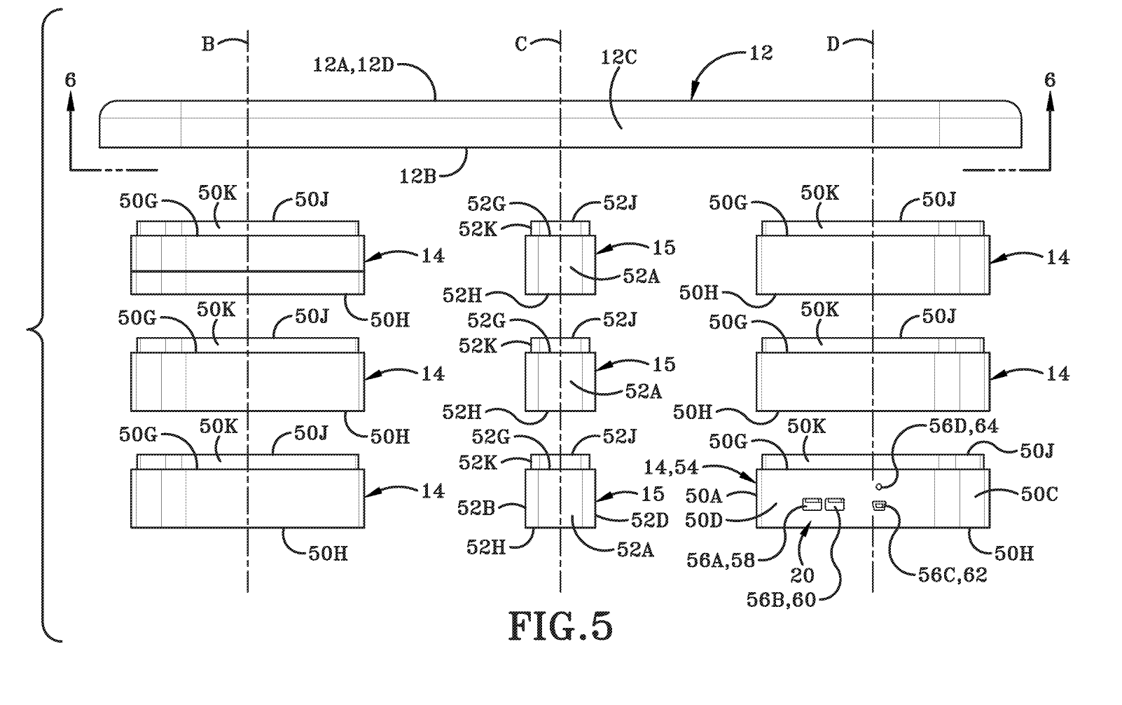

Referring to FIGS. 5 and 13, a stack of square risers 15 may be aligned with a first vertical axis B that is oriented at right angles to upper surface 12A of plate 12. A stack of risers 15 is aligned with each slot 36 on lower surface 12B of plate 12. The risers 15 in each stack of risers 15 are interlockingly engaged with each other and with plate 12 to provide vertical support for plate 12, as is shown in FIGS. 3 and 4. Similarly, a stack of rectangular risers 14 is aligned with each of a second vertical axis C and a third vertical axis D that extend at right angles to upper surface 12A of plate 12. One or more riser 54 is selectively included in one or more of the stacks of risers 14. Each stack of risers 14, 54 is aligned with one of the slots 38 on lower surface 12B of plate 12. The risers in each stack of risers 14, 54 are interlocked together and with plate 12 to provide vertical support for plate 12 as shown in FIGS. 3 and 4. Top risers in each stack of risers 14, 15 are interlocked with plate 12 as shown in FIG. 13 and as described below.

In one embodiment, two risers 14 and one riser 54 that are interlocked with each other to form a stack and these interlocked risers that are engaged with plate 12. A first riser 14 is aligned with the slot 38 defined in plate 12. Flange 50K of riser 14 is inserted into the opening 48 of slot 38. Because opening 48 defined by the walls 42 and flange 50K are complementary, flange 50K fits tightly inside the opening 48 and riser 14 is thereby interlocked with plate 12. The first riser 14 may be frictionally retained within slot 38.

A second riser 14 is aligned with and positioned beneath the first riser 14. The flange 50K of the second riser 14 is inserted into the opening defined by bottom end 50H of the first riser 14. Flange 50K of the second riser 14 is complementary to the opening defined by the bottom end 50H of the first riser 14. Consequently, when the flange 50K of the second riser 14 is inserted into the opening defined in the first riser 14, the second riser 14 is tightly interlocked with first riser 14. A third riser 14 (or riser 54 that includes the charging station 20) may then be engaged with the second riser 14 in a similar manner to the way the second riser 14 engages the first riser 14.

It will be understood that a stack of square risers 15 is formed and interlockingly engaged with each other and with plate 12 in a similar manner to how the stack of rectangular risers 14 are interlockingly engaged with each other and with the plate 12.

It will be understood that the riser 54 that includes charging station 20 may be positioned as the first riser, the second riser, or the third riser in the stack of rectangular risers. It will be further understood that riser 54 may be moved laterally to a different stack of risers 14 on the other side of plate 12 or the stack of risers that includes the riser 54 may change places with a stack of risers 14 that does not include a riser 54. It will be further understood that riser 54 may be rotated about an associated one of the vertical axes C or D to change the position of charging station 20 on a stack or risers. A user is therefore able to customize monitor stand 10 by selecting where to locate the charging station 20 and then locating riser 54 wherever he/she wants to position charging station 20 on plate 12. In other words, the user may select to vertically move riser 54 within one of the stacks of risers 14 or the user may horizontally move riser 54 from one stack of risers 14 to another stack of risers 14 or horizontally move the entire stack from adjacent one side of plate 12 to the other side thereof. Alternatively, the user may select to rotate riser 54 within the stack of risers 14.

In the first embodiment, three risers are provided in each stack of risers. However, in other embodiments, less than three or more than three risers can be used in each stack of risers. The same number of risers may be utilized in each of the stacks so that the plate 12 is retained in a horizontal orientation. It will be understood if it desired to angle plate 12, this may be done by selecting different numbers of risers in appropriate stacks of risers. It will also be understood that instead of having a plurality of different stacks of risers, a single larger stack of risers may be centrally located under plate 12. In this instance, the position of the riser that includes the charging station 20 will only be moveable by rotating the single riser 54 or the stack of interlocked risers. Furthermore, if desired charging station 20 or a smaller version thereof (such as a single USB port or a wireless charging pad) may be provided on one of the square risers 15.

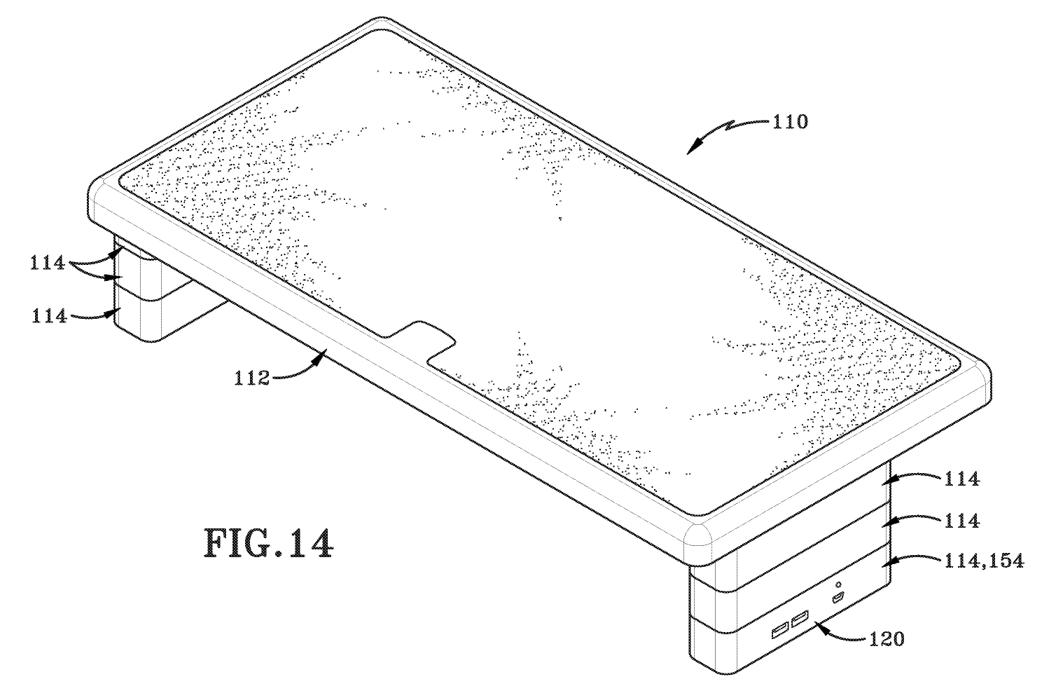

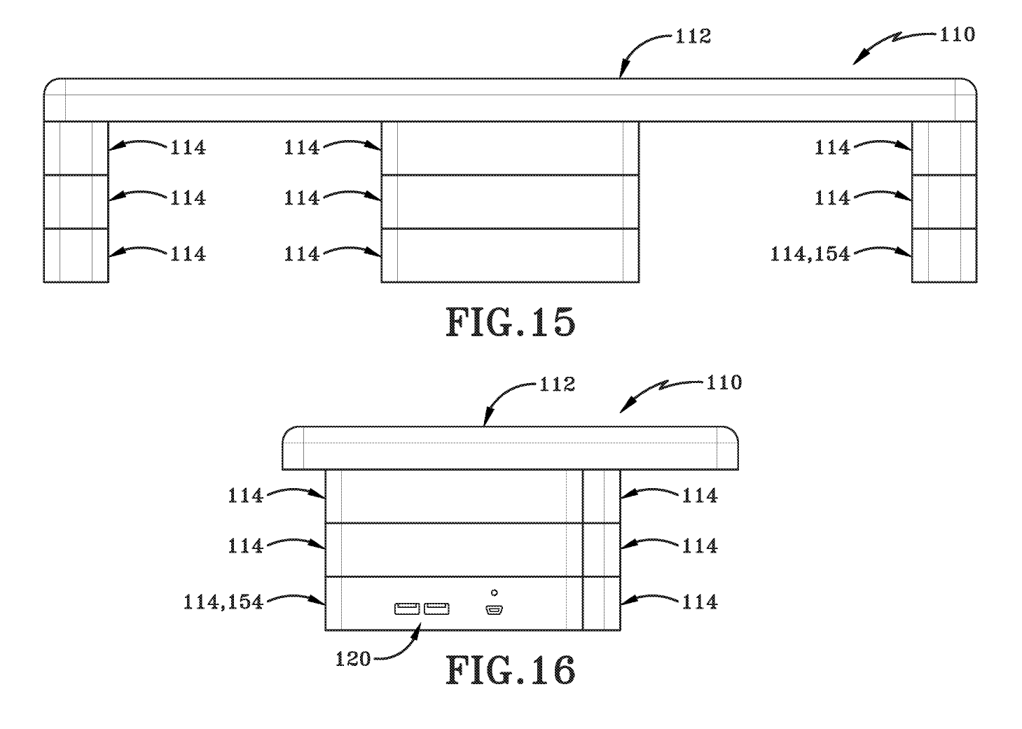

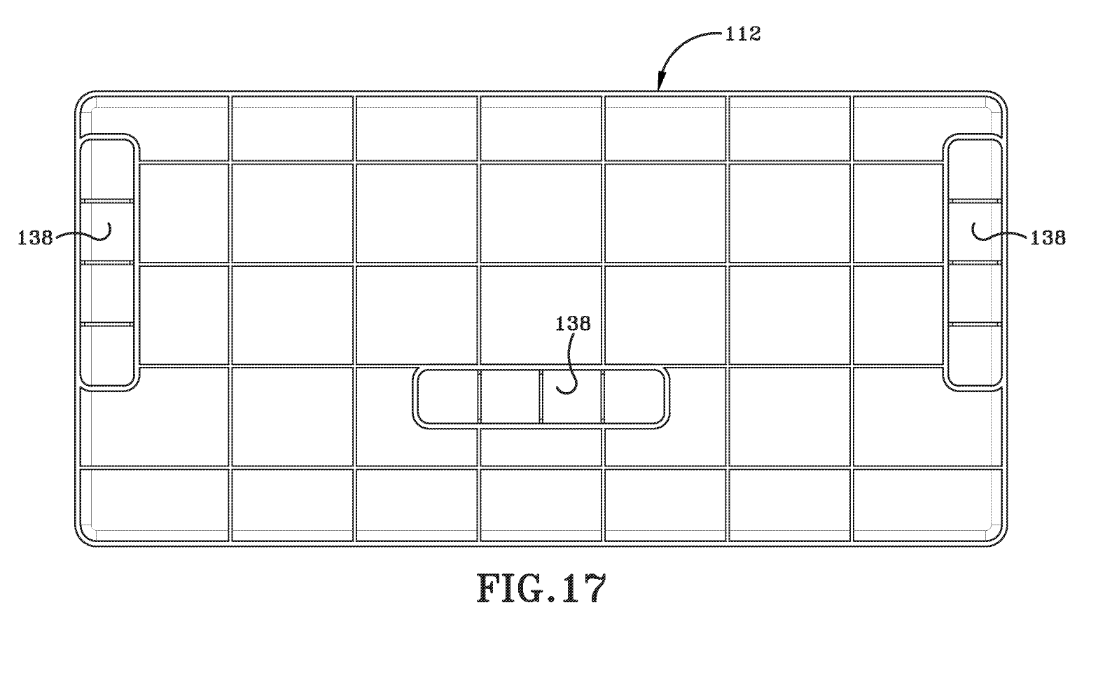

A second embodiment of a monitor stand 110 is illustrated in FIGS. 14-17. The monitor stand 110 comprises a plate 112 and a plurality of risers 114, 154, where the riser 154 includes charging station 120. The monitor stand 110 may be similar in structure and function to monitor stand 10 except that the plate 112 is rectangular in shape. Additionally, only rectangular shaped risers 114, 154 are utilized on the monitor stand 110 and the positioning of the slots 138 on plate 112 is selected to ensure that plate 112 is stably supported on a support surface. FIG. 17 shows a bottom view of plate 112. As shown in this figure, three slots 138 are defined in the plate 112, with each slot 138 being located proximate one of a side edge or a rear edge of plate 112. Three stacks of risers 114 may be engaged within the slots 138 to support the plate 112.

As with monitor stand 10, a user may select which stack of risers 114 within which to include riser 154. Riser 154 includes a charging station 120 that may be substantially identical in structure and function to charging station 20. It will be understood that less than or more than three slots 138 may be defined in the plate 112. Additionally, a number of less than or more than three risers 114, 154 may be utilized in each stack of risers. Furthermore, the user may customize the monitor stand 110 by moving riser 154 vertically within one of the stacks of risers 114 or by laterally moving riser 154 to a stack of different risers 114, or by swapping the stack including riser 154 with another stack of risers 114; or by rotating riser 154 within the same stack of the risers 114. It will be further understood that more than one riser 154 may be utilized in monitor stand 110.

Stated otherwise, the monitor stand 10 having the at least one riser 54 from the plurality of risers that includes charging station 20 adapted to provide power to an electrical device, wherein a position of the at least one riser 54 including the charging station 20 is variable relative to the plate 12. Plate 12 has a first position of the plate and a second position of the plate that is vertically different than the first position. The plurality of risers are interconnected to move the plate 12 from the first position to the second position. Riser 54 has an interlocking and the second riser 14. There is a first engagement position with the at least one riser 54 including the charging station 20 above the second riser 14, and a second engagement position with the at least one riser 54 including the charging station 20 below the second riser 14. There may be a third riser 14, and a third engagement position with the at least one riser 54 including the charging station 20 below the second riser and the third riser, a fourth engagement position with the at least one riser 54 including the charging station 20 above the second riser and the third riser, and a fifth engagement position with the at least one riser 54 including the charging station 20 between the second riser and the third riser. Additionally, there may be an interlocking engagement between the at least one riser 54 including the charging station 20 and the second surface of the plate 12. In this instance there is a first riser position with the at least one riser 54 including the charging station 20 adjacent a first end of the plate 12 below the second surface, and there is a second riser position with at least one riser 54 including the charging station 20 adjacent a second end of the plate 12 below the second surface. This could provide that a spacing of the charging station 20 relative to the second surface of the plate 12 that is equal in the first riser position and the second riser position, such as when moving riser 54 from the left side of the plate 12 to the right side of the plate 12 but being directly connected to the bottom surface thereof. However, it is possible to have a spacing of the charging station 20 relative to the second surface of the plate 12 that is different in the first riser position than in the second riser position such as when the charging station 20 is moved from the left side of the plate to the right side of the plate while also being vertically moved within the stack of risers.

There may also be a power source coupled with the charging station such that there is a first device placement position relative to an upper surface of the plate to charge the electrical device with the power source via the charging station and a second device placement position relative to an upper surface of the plate to charge the electrical device with the power source via the charging station, wherein the second device placement position is horizontally translated to a different location relative to the plate than the first device placement position. In this instance the device that is charging may be supported by the plate 12 near the left side and then can be moved to near the right side of the plate 12. In a similar regard, there may be a first device placement position relative to an upper surface of the plate to charge the electrical device with the power source via the charging station and a second device placement position relative to an upper surface of the plate to charge the electrical device with the power source via the charging station, wherein the second device placement position is moved vertically to a different location relative to the plate than the first device placement position.

Plate 12 is moveable between the raised position and the lowed position. A vertical spacing of the at least one riser 54 including the charging station 20 relative to a top surface of the plate 12 may remain equal when the position of the at least one riser including the charging station is laterally moved relative to the plate and as the plate is moved between the raised position and the lowered position.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A monitor stand comprising:
a plate having a first surface and a second surface and the plate is adapted to support an object;
a plurality of riser connected to the plate;
wherein at least one riser from the plurality of risers includes a charging station adapted to provide power to an electrical device, wherein a position of the at least one riser including the charging station is variable relative to the plate.

2. The monitor stand of claim 1, further comprising:
a first position of the plate and a second position of the plate that is vertically different than the first position;
wherein the plurality of risers are interconnected to move the plate from the first position to the second position.

3. The monitor stand of claim 2, further comprising:
an interlocking engagement between the at least one riser including the charging station and a second riser;
a first engagement position with the at least one riser including the charging station above the second riser; and
a second engagement position with the at least one riser including the charging station below the second riser.

4. The monitor stand of claim 3, further comprising:
a third riser;
a third engagement position with the at least one riser including the charging station below the second riser and the third riser;
a fourth engagement position with the at least one riser including the charging station above the second riser and the third riser;
a fifth engagement position with the at least one riser including the charging station between the second riser and the third riser.

5. The monitor stand of claim 2, further comprising:
an interlocking engagement between the at least one riser including the charging station and the second surface of the plate;
a first riser position with at least one riser including the charging station adjacent a first end of the plate below the second surface; and
a second riser position with at least one riser including the charging station adjacent a second end of the plate below the second surface.

6. The monitor stand of claim 5, further comprising:
a spacing of the charging station relative to the second surface of the plate that is equal in the first riser position and the second riser position.

7. The monitor stand of claim 5, further comprising:
a spacing of the charging station relative to the second surface of the plate that is different in the first riser position than in the second riser position.

8. The monitor stand of claim 1, further comprising:
a power source coupled with the charging station;
a first device placement position relative to an upper surface of the plate to charge the electrical device with the power source via the charging station;
a second device placement position relative to an upper surface of the plate to charge the electrical device with the power source via the charging station, wherein the second device placement position is horizontally translated to a different location relative to the plate than the first device placement position.

9. The monitor stand of claim 1, further comprising:
a power source coupled with the charging station;
a first device placement position relative to an upper surface of the plate to charge the electrical device with the power source via the charging station;
a second device placement position relative to an upper surface of the plate to charge the electrical device with the power source via the charging station, wherein the second device placement position is moved vertically to a different location relative to the plate than the first device placement position.

10. The monitor stand of claim 1, wherein the charging station includes at least one of a universal serial bus (USB) and a wireless charging pad.

11. The monitor stand of claim 1, further comprising:
an upper surface of the plate defining a major surface area and an opposed bottom surface;
a plurality of ribs formed in the bottom surface adapted to strengthen the plate;
a first slot defined in the bottom surface of the plate adjacent the plurality of ribs;
a second slot defined in the bottom surface of the plate adjacent the plurality of ribs spaced apart from the first slot;
a first engagement position where the at least one riser including the charging station is engaged with the first slot; and
a second engagement position where the at least one riser including the charging station is engaged with the second slot.

12. The monitor stand of claim 1, wherein the at least one riser including the charging station is one of laterally moveable, vertically moveable, and rotatable relative to the plate.

13. The monitor stand of claim 12, further comprising:
a raised position and a lowered position of the plate;
wherein a vertical spacing of the at least one riser including the charging station relative to a top surface of the plate remains equal when the position of the at least one riser including the charging station is laterally moved relative to the plate and as the plate is moved between the raised position and the lowered position.

14. The monitor stand of claim 1, wherein each riser from the plurality of risers includes:
a top end and a bottom end of each riser;
wherein the top end is formed with one of a male connector and a female connector; and
wherein the bottom end is formed with the other of a male connector and a female connector.

15. The monitor stand of claim 14, wherein each male and female connector has identically shaped sides to allow for assembly in more than one orientation relative to a vertical axis of the riser.

16. A charging system comprising:
a plate having an upper surface and an opposed lower surface that is moveable between a raised position and a lowered position;
a first riser located under the lower surface of the plate that is variable relative to the plate to effectuate movement of the plate between the raised position and the lowered position;
a charging station located on the first riser that is variable in location relative to an engagement position with the plate;
a power source coupled with the charging station;
an electronic device; and
an electrical connection between the electronic device and the charging station, wherein the electrical connection may be selected from the group comprising (i) a wired connection and (ii) a wireless connection.

17. The charging system of claim 16, wherein the charging station comprises at least one of a USB port, an electrical outlet, a circuit board, a wireless charging pad, and an LED indicator.

18. A method comprising:
varying a position of a riser including a charging station relative to a surface on a plate;
connecting an electrical device to the charging station; and
charging the electrical device.

19. The method of claim 18, further comprising:
moving the plate between a raised position and a lowered position, wherein moving the plate is accomplished by altering a number of risers that are stacked below the plate; and
varying the position of the riser including the charging station in the number of risers stacked below the plate.

20. The method of claim 19, further comprising:
interlocking a plurality of risers together;
interlocking one riser to a bottom surface of the plate in a first slot defined in the bottom surface of the plate adjacent a plurality of ribs;
interlocking one riser to the bottom surface of the plate in a second slot defined in the bottom surface of the plate adjacent the plurality of ribs spaced apart from the first slot;
moving at least one riser including the charging station from a first engagement position with the first slot to a second engagement position with the second slot.
